(19) United States
(12) Patent Application Publication
(10) Pub. No.: US 2025/0143941 A1
(43) Pub. Date: May 8, 2025

(54) EXPANSION CONTROL ASSEMBLY

(71) Applicant: Sizewise Rentals L.L.C., Lenexa, KS (US)

(72) Inventors: Jeffery SPREIER, Hays, KS (US); David Delroy DRISCOLL, JR., Milwaukee, WI (US); Michael Andrew VERHAGEN, Heartland, WI (US); Duane E. WENTE, III, Hays, KS (US); Matthew Ray ISLEY, Hays, KS (US); Troy PARSON, Ellis, KS (US)

(73) Assignee: Sizewise Rentals L.L.C., Lenexa, KS (US)

(21) Appl. No.: 18/940,130

(22) Filed: Nov. 7, 2024

Related U.S. Application Data
(60) Provisional application No. 63/596,693, filed on Nov. 7, 2023.

(51) Int. Cl. A61G 7/05

(52) U.S. Cl. CPC A61G 7/0512; A61G 7/0509

(57) ABSTRACT

An expansion control assembly may include a stabilizer connected to a deck frame, the stabilizer having a lateral receiver and a sliding member extending through the lateral receiver, the sliding member connected to an adjustable side deck. An expansion control assembly may include a bottom bracket connected to the stabilizer, the bottom bracket comprising a first retaining element and a second retaining element. An expansion control assembly may include a latch pivotally connected to the adjustable side deck, the latch comprising a first tab and an engaging element configured to engage the first retaining element and the second retaining element. Methods of moving an adjustable side deck may include rotation of the latch away from the bottom bracket and sliding the latch away from, or towards, the deck frame.

### CROSS-REFERENCE TO RELATED APPLICATION

This application claims priority to U.S. Provisional Application No. 63/596,693 filed Nov. 7, 2023, the contents of which are hereby incorporated by reference.

### FIELD OF THE DISCLOSED SUBJECT MATTER

The disclosed subject matter generally relates to expansion control assemblies, and more particularly, but not necessarily exclusively, to an expansion control assembly for medical beds.

### SUMMARY

In some aspects, the disclosed subject matter described herein relates to an expansion control assembly including: a stabilizer connected to a deck frame, the stabilizer having a lateral receiver and a sliding member extending through the lateral receiver, the sliding member connected to an adjustable side deck; a bottom bracket connected to the stabilizer, the bottom bracket including a first retaining element and a second retaining element; and a latch pivotally connected to the adjustable side deck, the latch including a first tab and an engaging element configured to engage the first retaining element and the second retaining element, whereby rotation of the first tab away from the deck frame releases the latch from the bottom bracket and allows for movement of the adjustable side deck between a retracted position and an expanded position.

In some aspects, the disclosed subject matter described herein relates to an expansion control assembly further comprising a compression element connected between the adjustable side deck and the latch, wherein the compression element urges the engaging element towards the bottom bracket.

In some aspects, the disclosed subject matter described herein relates to an expansion control assembly, wherein the compression element is a spring.

In some aspects, the disclosed subject matter described herein relates to an expansion control assembly, wherein the adjustable side deck is placed in the retracted position when the engaging element engages the first retaining element.

In some aspects, the disclosed subject matter described herein relates to an expansion control assembly, wherein the adjustable side deck is placed in the expanded position when the engaging element engages the second retaining element.

In some aspects, the disclosed subject matter described herein relates to an expansion control assembly, wherein the sliding member includes at least one cylindrical body.

In some aspects, the disclosed subject matter described herein relates to an expansion control assembly, further including: a side rail locking mechanism including: a side rail bracket connected to the adjustable side deck including: a bottom surface; a first aperture extending through the side rail bracket and the bottom surface; and an extension tab extending away from the first aperture; the extension tab having a second aperture extending therethrough; a second tab pivotally connected to the adjustable side deck; and a locking member connected to the first tab and extending through the second aperture, whereby rotation of the second tab away from the side rail bracket urges the locking member to move at least partially through the second aperture and away from the side rail bracket.

In some aspects, the disclosed subject matter described herein relates to an expansion control assembly, wherein the second tab is positioned proximate the first tab.

In some aspects, the disclosed subject matter described herein relates to an expansion control assembly, wherein the latch includes a first side member and a second side member, wherein the second tab extends downwardly between the first side member and the second side member.

In some aspects, the disclosed subject matter described herein relates to an expansion control assembly further includes a side rail assembly including an attachment member, wherein the attachment member is demountably connected to the expansion control assembly via insertion of the attachment member into the first aperture.

In some aspects, the disclosed subject matter described herein relates to an expansion control assembly including: a stabilizer connected to a deck frame, the stabilizer having a lateral receiver and a sliding member extending through the lateral receiver, the sliding member connected to an adjustable side deck; a bottom bracket connected to the stabilizer, the bottom bracket including a first retaining element and a second retaining element; a latch pivotally connected to the adjustable side deck, the latch including a first tab and an engaging element configured to engage the first retaining element and the second retaining element; a side rail locking mechanism including: a side rail bracket connected to the adjustable side deck including: a bottom surface; a first aperture extending through the side rail bracket and the bottom surface; and an extension tab extending away from the first aperture, the extension tab having a second aperture extending therethrough; a second tab pivotally connected to the adjustable side deck; and a locking member connected to the first tab and extending through the second aperture, whereby rotation of the first tab away from the deck frame releases the latch from the bottom bracket and allows for movement of the adjustable side deck between a retracted position and an expanded position, whereby rotation of the second tab away from the side rail bracket urges the locking member to move at least partially through the second aperture and away from the side rail bracket.

In some aspects, the disclosed subject matter described herein relates to an expansion control assembly, further including a compression element connected between the adjustable side deck and the latch, wherein the compression element urges the engaging element towards the bottom bracket.

In some aspects, the disclosed subject matter described herein relates to an expansion control assembly, wherein the adjustable side deck is placed in the retracted position when the engaging element engages the first retaining element.

In some aspects, the disclosed subject matter described herein relates to an expansion control assembly, wherein the adjustable side deck is placed in the expanded position when the engaging element engages the second retaining element.

In some aspects, the disclosed subject matter described herein relates to an expansion control assembly, wherein the sliding member includes at least one cylindrical body.

In some aspects, the disclosed subject matter described herein relates to an expansion control assembly, wherein the second tab is positioned proximate the first tab.

In some aspects, the disclosed subject matter described herein relates to an expansion control assembly, wherein the latch includes a first side member and a second side member, wherein the second tab extends downwardly between the first side member and the second side member.

In some aspects, the disclosed subject matter described herein relates to an expansion control assembly, further including a side rail assembly including an attachment member, wherein the attachment member is demountably connected to the expansion control assembly via insertion of the attachment member into the first aperture.

In some aspects, the disclosed subject matter described herein relates to a method of moving an adjustable side deck including the steps of: providing an expansion control assembly connected between a deck frame and an adjustable side deck, the expansion control assembly including: a stabilizer connected to the deck frame; the stabilizer having a lateral receiver and a sliding member extending through the lateral receiver, the sliding member connected to the adjustable side deck; a bottom bracket connected to the stabilizer; the bottom bracket including a first retaining element and a second retaining element; and a latch pivotally connected to the adjustable side deck, the latch including a first tab and an engaging element configured to engage the first retaining element and the second retaining element; pulling the first tab away from the deck frame; rotating the latch away from the bottom bracket; sliding the latch away from the deck frame; releasing the first tab; and engaging the engaging element with the second retaining element; thereby moving the adjustable side deck from a retracted position associated with the first retaining element to an expanded position associated with the second retaining element.

In some aspects, the disclosed subject matter described herein relates to a method of moving an adjustable side deck further including the steps of: pulling the first tab away from the deck frame; rotating the latch away from the bottom bracket; sliding the latch towards the deck frame; releasing the first tab; and engaging the engaging element with the first retaining element; thereby moving the adjustable side deck from an expanded position associated with the second retaining element to a retracted position associated with the first retaining element.

### BRIEF DESCRIPTION OF THE DRAWINGS

The disclosed subject matter is described herein with reference to the following drawing figures, with greater emphasis being placed on clarity rather than scale:

FIG. 1 is a top view of an expandable deck assembly having adjustable side decks in a retracted position.

FIG. 2 is a top view of an expandable deck assembly having adjustable side decks in an expanded position.

FIG. 3 is an isometric view of an expandable deck assembly having adjustable side decks in an expanded position.

FIG. 4 is an isometric view of an expansion control assembly connected to a side rail assembly.

FIG. 5 is an isometric view of an expansion control assembly connected to an adjustable side deck.

FIG. 6 is a bottom view of the expansion control assembly and connected to an adjustable side deck.

FIG. 7 is a cross-sectional view of the expansion control assembly.

FIG. 8 is a cross-sectional view of the expansion control assembly.

FIG. 9 is a bottom view of the expansion control assembly.

FIG. 10 is a flowchart of a method for expanding an adjustable side deck from a deck frame.

FIG. 11 is a flowchart of a method for retracting an adjustable side deck from a deck frame.

FIG. 12 is a flowchart of a method for connecting a side rail assembly to a deck frame.

FIG. 13 is a flowchart of a method for detaching a side rail assembly to a deck frame.

FIG. 14 is an isometric view of an embodiment of a side rail assembly and side rail hinge.

### DETAILED DESCRIPTION

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Although the disclosed subject matter has been disclosed with reference to various embodiments, it is understood that equivalents may be employed, and substitutions made herein without departing from the scope of the disclosed subject matter as recited in the claims.

Certain terminology will be used in the following description, and are shown in the drawings, and will not be limiting. For example, up, down, front, back, right, and left refer to the disclosed subject matter as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

The disclosed subject matter will now be described with reference to the drawing figures, in which like reference numerals refer to like parts throughout. For purposes of clarity in illustrating the characteristics of the present disclosed subject matter, proportional relationships of the elements have not been maintained in the figures. In some cases, the sizes of certain small components have been exaggerated for illustration.

Although the subject matter has been disclosed with reference to various particular embodiments, it is understood that equivalents may be employed and substitutions made herein without departing from the scope of the subject matter.

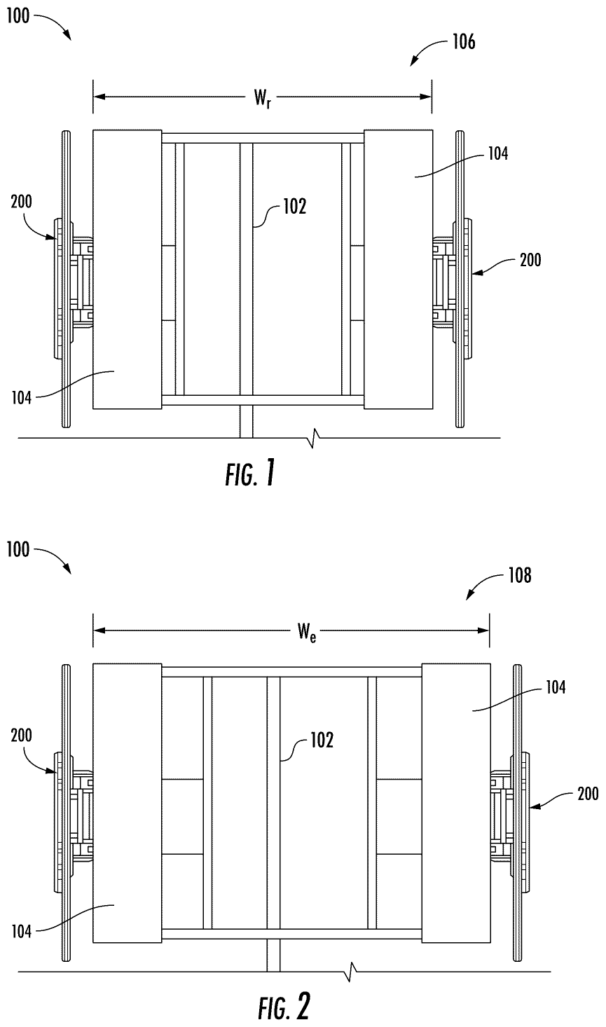

Referring to the drawings, FIGS. 1-2 show an embodiment of an expandable deck assembly 100, wherein the expandable deck assembly 100 includes a deck frame 102 and adjustable side decks 104 movably connected to the deck frame 102. The adjustable side decks 104 may be laterally adjusted between a retracted position 106 having a retracted width Wᵣ and an expanded position 108 having an expanded width Wₑ, wherein Wₑ is greater than Wᵣ. In an embodiment, Wᵣ is less than about 36 inches and Wᵣ is greater than about 42 inches. In another embodiment, Wᵣ is about 35.5 inches, and Wₑ is about 42.5 inches.

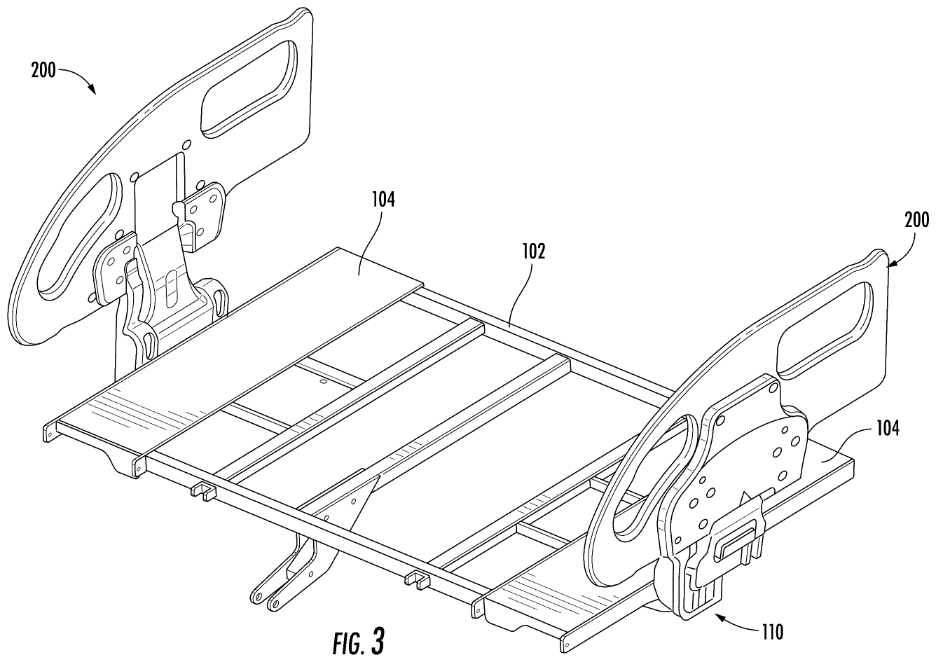

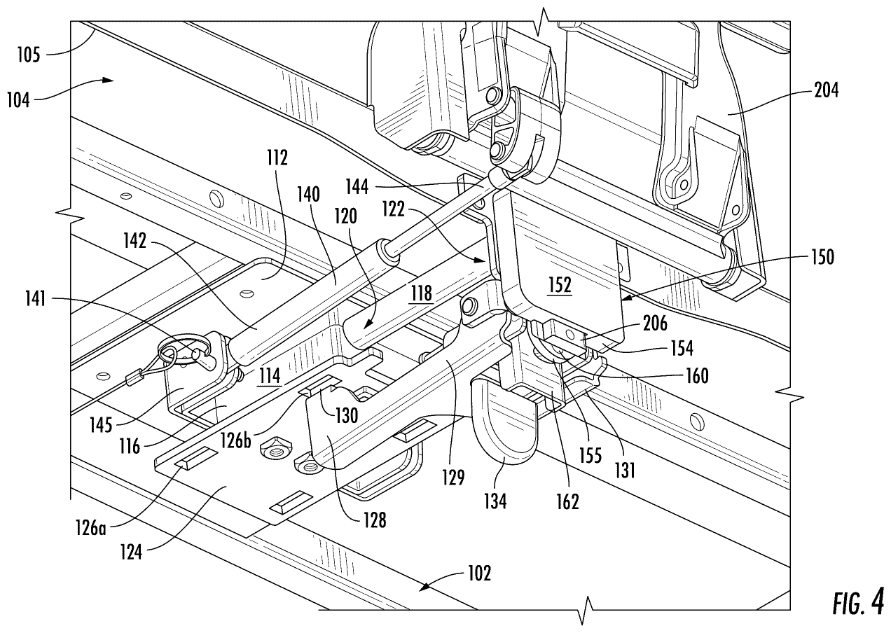

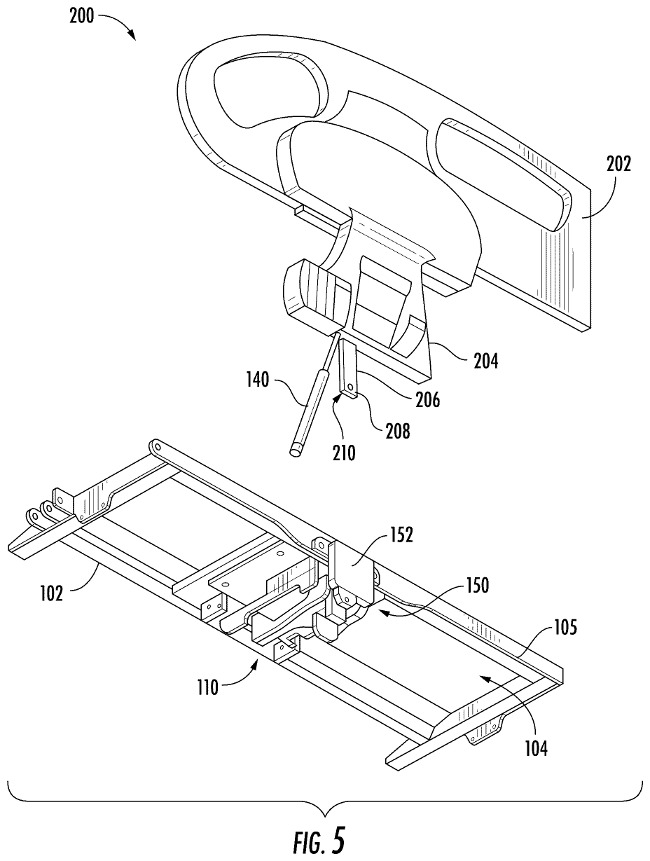

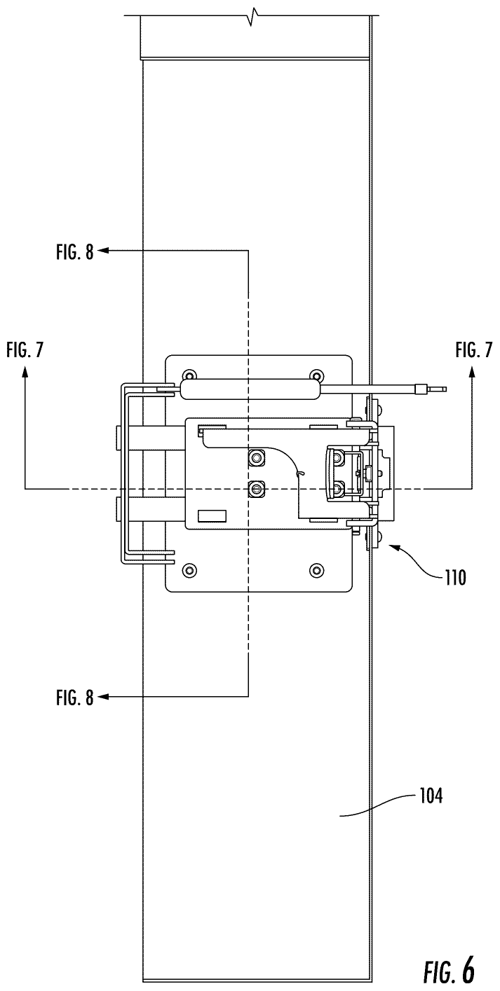

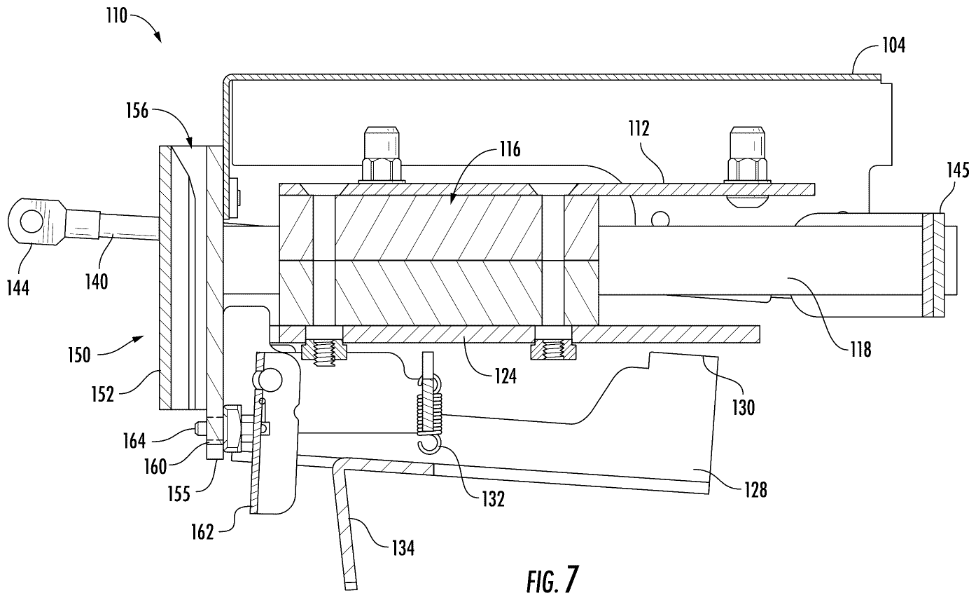

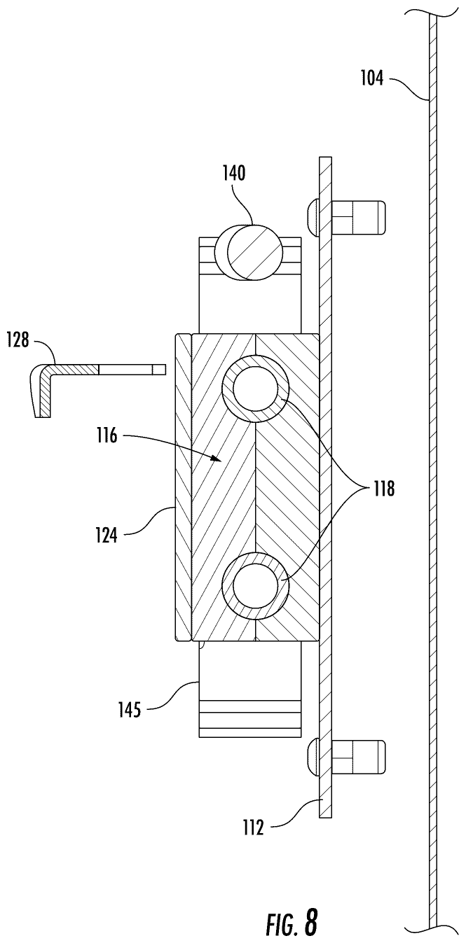

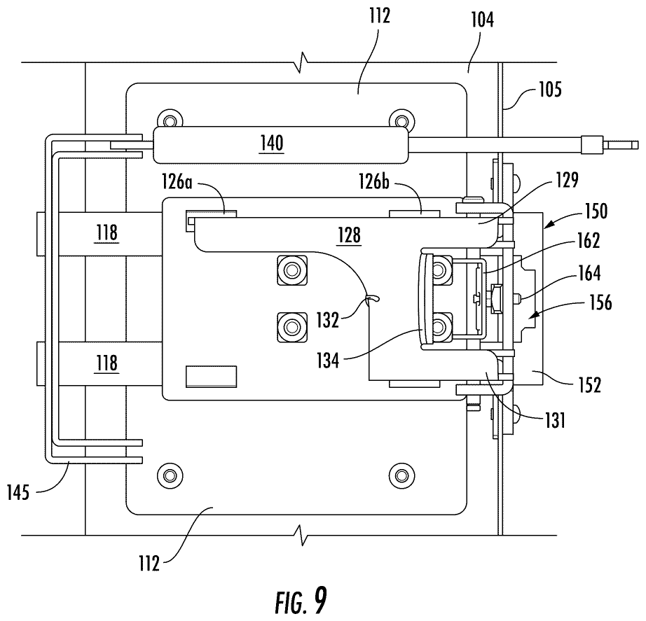

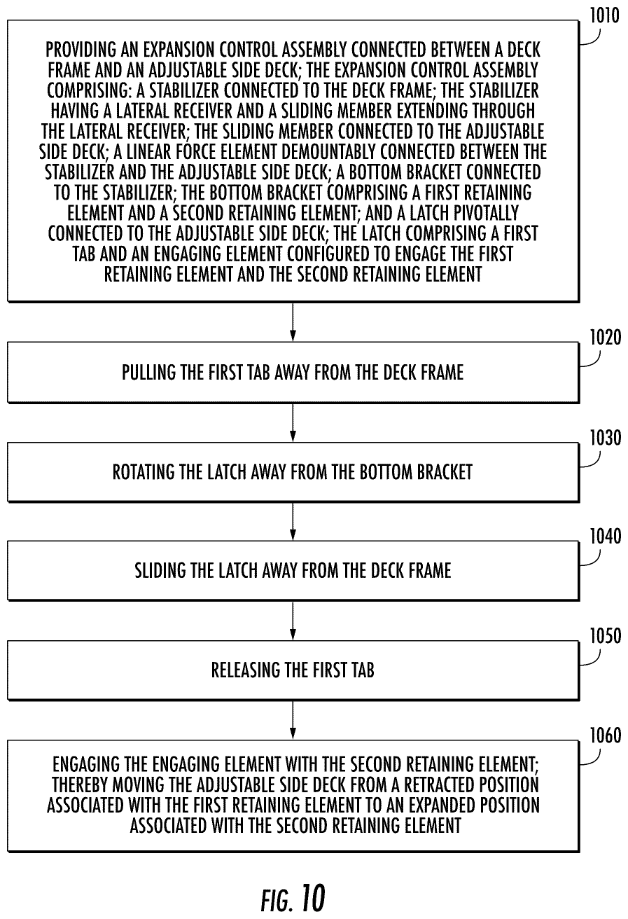

Referring to the drawings, FIGS. 3-9 show an embodiment of an expansion control assembly 110 that may be connected between the deck frame 102 and one of the adjustable side decks 104. The expansion control assembly 110 includes: a top bracket 112 connected to the deck frame 102; and a stabilizer 114 having a lateral receiver 116 connected to the top bracket 112, and a sliding member 118 extending through the lateral receiver 116. The lateral receiver 116 is configured to support a first distal end 120 of the sliding member 118 as it travels within the lateral receiver 116. A second distal end 122 of the sliding member 118 is attached to the one of the adjustable side decks 104 proximate a deck edge 105. In an embodiment, the sliding member 118 comprises two cylindrical bodies in generally parallel arrangement. The sliding member 118 is connected to an extension bracket 145 proximate the first distal end 120. The expansion control assembly 110 further comprises a bottom bracket 124 connected to the lateral receiver 116 opposite the top bracket 112. The bottom bracket 124 may comprise a first retaining element 126a and a second retaining element 126b laterally spaced a distance D apart from the first retaining element 126a; wherein the distance D corresponds to a predetermined distance of the travel of one of the adjustable side decks 104. The first retaining element 126a and the second retaining element 126b may comprise a hole, notch, slot, indentation, protrusion, tab or other suitable means of restraint a latch 128 pivotally connected to the one of the adjustable side decks 104.

The latch 128 comprises an engaging element 130 configured to engage the first retaining element 126a or second retaining element 126b. The engaging element 130 may comprise a tab, pin, projection, protrusion, extension, or other suitable mechanical means of engaging the first retaining element 126a and second retaining element 126b. The latch 128 is restricted from lateral (side-to-side) movement when the engaging element 130 engages one of the first retaining element 126a or second retaining element 126b. The latch 128 may be rotated away from the bottom bracket 124 by pivoting a portion of the latch 128 away from the adjustable side decks 104. Once pivoted away from the bottom bracket 124, the latch 128 may be pushed towards or pulled away from the deck frame 102. The latch 128 may then reengage one of the first retaining element 126a or second retaining element 126b by rotating the latch 128 upwards toward the bottom bracket 124. In an embodiment, the latch 128 is urged upwards by a compression element 132, such a spring, which rotates the latch 128 upwardly towards the bottom bracket 124. The latch 128 may further comprise a first tab 134 extending downwardly from the latch 128 and configured to be pulled by a user away from the deck frame 102 to rotate the latch 128 downwardly; thereby disengaging the engaging element 130 from one of the first retaining element 126a or the second retaining element 126b. Once the engaging element 130 is disengaged from the first retaining element 126a and the second retaining element 126b, the latch 128 and one of the adjustable side decks 104 connected to the latch 128 may be adjusted between the retracted position 106 and the expanded position 108.

In an embodiment, the expansion control assembly 110 includes a linear force element 140 having a third distal end 142 and a fourth distal end 144. The linear force element 140 is pivotally and demountably connected to the stabilizer 114 proximate the third distal end 142 and pivotally connected to a side rail hinge 204 proximate the fourth distal end 144. The linear force element 140 may be connected between the stabilizer 114 and one of the adjustable side decks 104. A clevis pin 141 may be used to pivotally connect the third distal end 142 to the extension bracket 145. The linear force element 140 may comprise a spring cylinder. The linear force element 140 may be compressed when the side rail hinge 204 rotates downwardly.

In an embodiment, the first tab 134 may be pulled away from the deck frame 102, thereby rotating the latch 128 from the bottom bracket 124. If the latch 128 was in the retracted position 106, the latch 128 may then be slid away from the deck frame 102 towards the expanded position 108. Once at the expanded position 108 the first tab 134 may be released and the engaging element 130 may engage the second retaining element 126b. In an embodiment, rotation of the latch 128 away from the deck frame 102 releases the latch 128 from the bottom bracket 124 and allows for movement of the adjustable side deck 104 between a retracted position 106 and an expanded position 108.

In another embodiment, the first tab 134 may be pulled away from the deck frame 102, thereby rotating the latch 128 from the bottom bracket 124. If the latch 128 was in the expanded position 108, the latch 128 may then be slid towards from the deck frame 102 towards the retracted position 106. Once at the retracted position 106 the first tab 134 may be released and the engaging element 130 may engage the first retaining element 126a.

In an embodiment, the expansion control assembly 110 includes a side rail locking mechanism 150 connected to the adjustable side decks 104. The side rail locking mechanism 150 includes a side rail bracket 152 having a bottom surface 154 and a first aperture 156 vertically extending through the side rail bracket 152. The side rail locking mechanism 150 may further include an extension tab 155 disposed proximate to bottom surface 154, wherein the extension tab 155 extends downwardly and away from the bottom surface 154. The extension tab 155 may comprise a second aperture 160 extending therethrough. The side rail locking mechanism 150 may include a second tab 162 having a locking member 164; wherein the locking member 164 is configured to extend at least partially through the second aperture 160 of the extension tab 155 and engage a third aperture 208. In an embodiment, the locking member 164 may comprise a cylindrical pin. The second tab 162 is configured to pivot towards the deck frame 102 and slide the locking member 164 through the second aperture 160. The second tab 162 is positioned proximate the first tab 134 so a user may push the second tab 162 or pull the first tab 134 using one hand. In an embodiment, the second tab 162 extends downwardly between a first side member 129 and a second side member 131 of the latch 128; wherein each of the first side member 129 and the second side member 131 are pivotally connected one of the adjustable side decks 104. In an embodiment, the first tab 134 may include a first color such as the color green, and the second tab 162 may include a second color such as the color red to contrast the first color assist in identification of the first tab 134 and the second tab 162.

In an embodiment, a side rail assembly 200 may be demountably connected to the expansion control assembly 110. The side rail assembly 200 may include a side rail body 202 extending upwardly from the one of the adjustable side decks 104. Side rail body 202 may be raised and lowered by means of a side rail hinge 204 connected between the expansion control assembly 110 and the side rail body 202. The side rail hinge 204 may include an attachment member 206 extending downwardly from the side rail hinge 204. The attachment member 206 may include a third aperture 208 disposed proximate a distal end 210. The attachment member 206 is configured to demountably connect to the side rail locking mechanism 150. The attachment member 206 may be inserted into the first aperture 156 of the side rail bracket 152 and secured within the side rail bracket 152 though insertion of the locking member 164 into the third aperture 208. A user may remove the side rail assembly 200 from the side rail locking mechanism 150 by pushing the second tab 162 towards the deck frame 102; thereby moving the locking member 164 out of the third aperture 208, and then pulling the attachment member 206 out of the first aperture 156 of the side rail bracket 152.

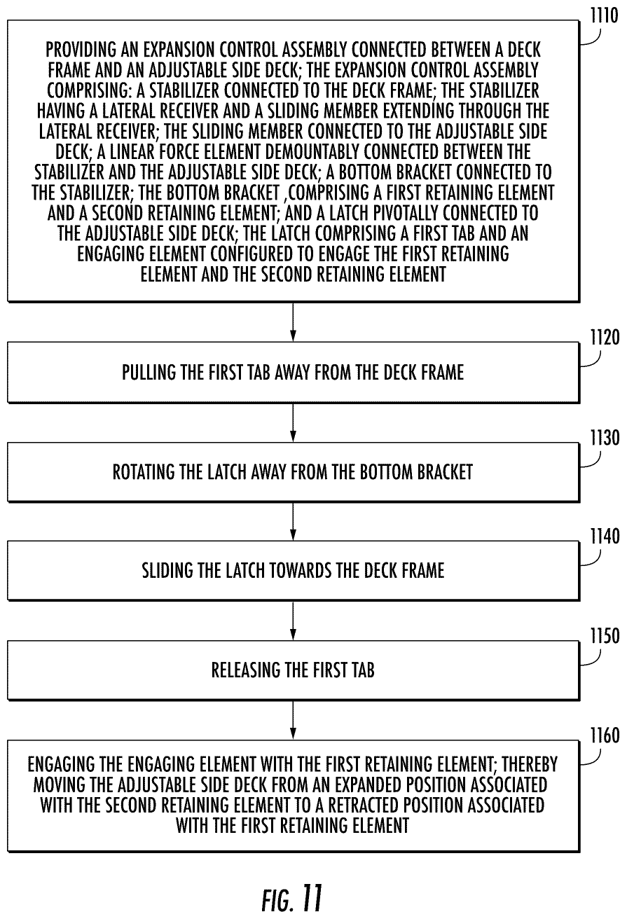

FIG. 10 is a flowchart of an example method for moving an adjustable side deck from a deck frame comprises the steps of:

At step 1010, providing an expansion control assembly connected between a deck frame and an adjustable side deck; the expansion control assembly comprising: a stabilizer connected to the deck frame; the stabilizer having a lateral receiver and a sliding member extending through the lateral receiver; the sliding member connected to the adjustable side deck; a linear force element demountably connected between the stabilizer and the adjustable side deck; a bottom bracket connected to the stabilizer; the bottom bracket comprising a first retaining element and a second retaining element; and a latch pivotally connected to the adjustable side deck; the latch comprising a first tab and an engaging element configured to engage the first retaining element and the second retaining element.

At step 1020, pulling the first tab away from the deck frame.

At step 1030, rotating the latch away from the bottom bracket.

At step 1040, sliding the latch away from the deck frame.

At step 1050, releasing the first tab.

At step 1060, engaging the engaging element with the second retaining element; thereby moving the adjustable side deck from a retracted position associated with the first retaining element to an expanded position associated with the second retaining element.

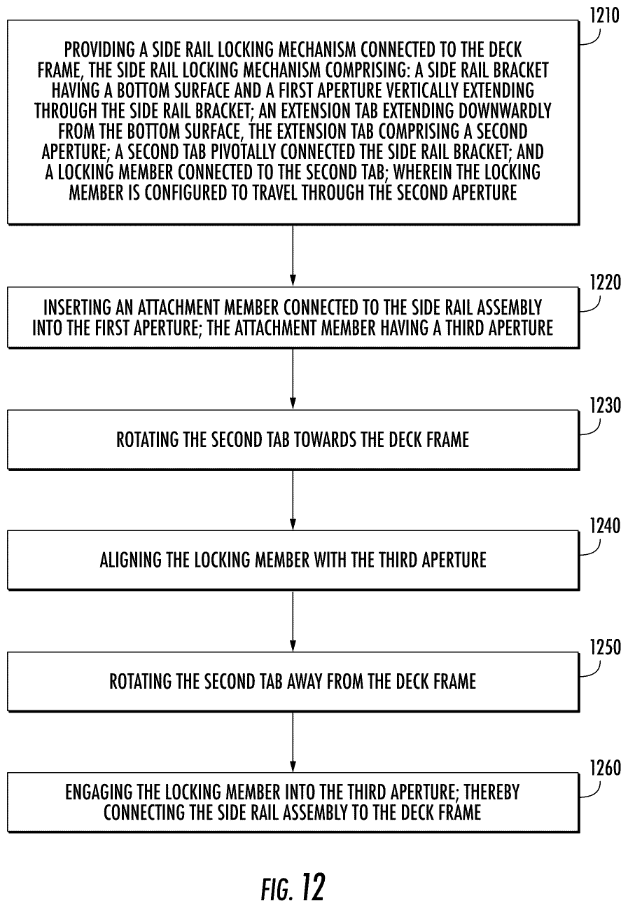

FIG. 11 is a flowchart of an example method for moving an adjustable side deck from a deck frame comprises the steps of:

At step 1110, providing an expansion control assembly connected between a deck frame and an adjustable side deck; the expansion control assembly comprising: a stabilizer connected to the deck frame; the stabilizer having a lateral receiver and a sliding member extending through the lateral receiver; the sliding member connected to the adjustable side deck; a linear force element demountably connected between the stabilizer and the adjustable side deck; a bottom bracket connected to the stabilizer; the bottom bracket comprising a first retaining element and a second retaining element; and a latch pivotally connected to the adjustable side deck; the latch comprising a first tab and an engaging element configured to engage the first retaining element and the second retaining element.

At step 1120, pulling the first tab away from the deck frame.

At step 1130, rotating the latch away from the bottom bracket.

At step 1140, sliding the latch towards the deck frame.

At step 1150, releasing the first tab.

At step 1160, engaging the engaging element with the first retaining element; thereby moving the adjustable side deck from an expanded position associated with the second retaining element to a retracted position associated with the first retaining element.

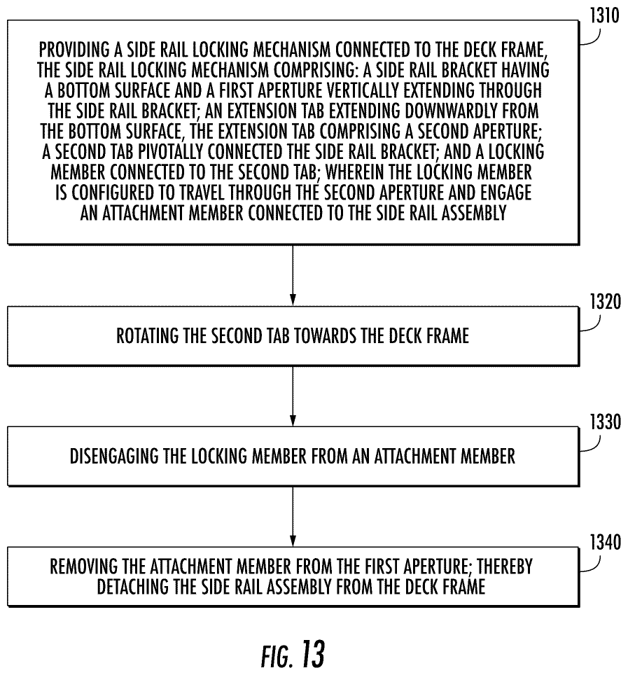

FIG. 12 is a flowchart of an example method for connecting a side rail assembly to a deck frame, comprising the steps of:

At step 1210, providing a side rail locking mechanism connected to the deck frame, the side rail locking mechanism comprising: a side rail bracket having a bottom surface and a first aperture vertically extending through the side rail bracket; an extension tab extending downwardly from the bottom surface, the extension tab comprising a second aperture; a second tab pivotally connected the side rail bracket; and a locking member connected to the second tab; wherein the locking member is configured to travel through the second aperture.

At step 1220, inserting an attachment member connected to the side rail assembly into the first aperture; the attachment member having a third aperture.

At step 1230, rotating the second tab towards the deck frame.

At step 1240, aligning the locking member with the third aperture.

At step 1250, rotating the second tab away from the deck frame.

At step 1260, engaging the locking member into the third aperture; thereby connecting the side rail assembly to the deck frame.

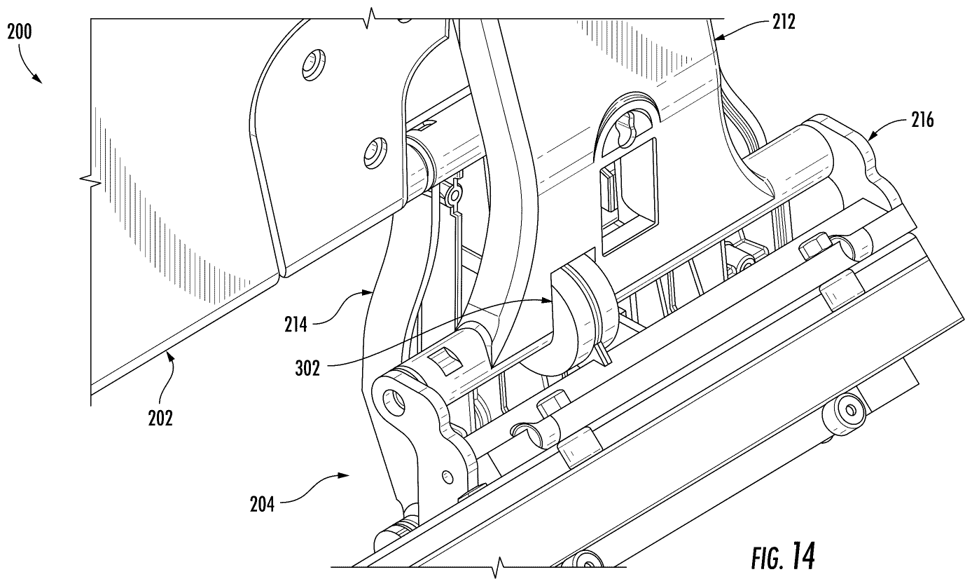

FIG. 13 is a flowchart of an example method for detaching a side rail assembly from a deck frame, comprising the steps of:

At step 1310, providing a side rail locking mechanism connected to the deck frame, the side rail locking mechanism comprising: a side rail bracket having a bottom surface and a first aperture vertically extending through the side rail bracket; an extension tab extending downwardly from the bottom surface, the extension tab comprising a second aperture; a second tab pivotally connected the side rail bracket; and a locking member connected to the second tab; wherein the locking member is configured to travel through the second aperture and engage an attachment member connected to the side rail assembly.

At step 1320, rotating the second tab towards the deck frame.

At step 1330, disengaging the locking member from the attachment member.

At step 1340, removing the attachment member from the first aperture; thereby detaching the side rail assembly from the deck frame.

Referring to the drawings, FIG. 14 illustrates an embodiment of the side rail assembly 200 where a rotary damper 302 may be used in place of the linear force element 140 (shown in FIG. 4) in order to control the downward movement of the side rail body 202 when the side rail body 202 is moved between a raised position and a lowered position. In an embodiment, the side rail hinge 204 may include an upper swing arm 212 and a lower swing arm 214, wherein each of the upper swing arm 212 and the lower swing arm 214 are pivotally connected to a swing arm bracket 216, thereby forming a parallel linkage between the side rail body 202 and swing arm bracket 216. In an embodiment, the rotary damper 302 is connected between the upper swing arm 212 and the swing arm bracket 216. In another embodiment (not shown), the rotary damper 302 may be connected between the lower swing arm 214 and the swing arm bracket 216. The rotary damper 302 may create a resisting rotational torque when the side rail body 202 is moved between the raised position and the lowered position, thereby preventing a sudden drop of the side rail body 202. In another embodiment, the rotary damper 302 may be connected between the side rail body 202 and one of the upper swing arm 212 and the lower swing arm 214, thereby creating a resisting rotational torque to the parallel linkage and preventing a sudden drop of the side rail body.

It is to be understood that while certain aspects of the disclosed subject matter have been shown and described, the disclosed subject matter is not limited hereto and encompasses various other embodiments as aspects.

1. An expansion control assembly comprising:
a stabilizer connected to a deck frame, the stabilizer having a lateral receiver and a sliding member extending through the lateral receiver, the sliding member connected to an adjustable side deck;
a bottom bracket connected to the stabilizer, the bottom bracket comprising a first retaining element and a second retaining element; and
a latch pivotally connected to the adjustable side deck, the latch comprising a first tab and an engaging element configured to engage the first retaining element and the second retaining element,
whereby rotation of the first tab away from the deck frame releases the latch from the bottom bracket and allows for movement of the adjustable side deck between a retracted position and an expanded position.

2. The expansion control assembly of claim 1 further comprising a compression element connected between the adjustable side deck and the latch, wherein the compression element urges the engaging element towards the bottom bracket.

3. The expansion control assembly of claim 2, wherein the compression element is a spring.

4. The expansion control assembly of claim 1, wherein the adjustable side deck is placed in the retracted position when the engaging element engages the first retaining element.

5. The expansion control assembly of claim 1, wherein the adjustable side deck is placed in the expanded position when the engaging element engages the second retaining element.

6. The expansion control assembly of claim 1, wherein the sliding member comprises at least one cylindrical body.

7. The expansion control assembly of claim 1 further comprising:
a side rail locking mechanism comprising:
a side rail bracket connected to the adjustable side deck comprising:
a bottom surface;
a first aperture extending through the side rail bracket and the bottom surface; and
an extension tab extending away from the first aperture; the extension tab having a second aperture extending therethrough;
a second tab pivotally connected to the adjustable side deck; and
a locking member connected to the first tab and extending through the second aperture,
whereby rotation of the second tab away from the side rail bracket urges the locking member to move at least partially through the second aperture and away from the side rail bracket.

8. The expansion control assembly of claim 7, wherein the second tab is positioned proximate the first tab.

9. The expansion control assembly of claim 7, wherein the latch comprises a first side member and a second side member, wherein the second tab extends downwardly between the first side member and the second side member.

10. The expansion control assembly of claim 7 further comprising a side rail assembly comprising an attachment member, wherein the attachment member is demountably connected to the expansion control assembly via insertion of the attachment member into the first aperture.

11. An expansion control assembly comprising:
a stabilizer connected to a deck frame, the stabilizer having a lateral receiver and a sliding member extending through the lateral receiver, the sliding member connected to an adjustable side deck;
a bottom bracket connected to the stabilizer, the bottom bracket comprising a first retaining element and a second retaining element;
a latch pivotally connected to the adjustable side deck, the latch comprising a first tab and an engaging element configured to engage the first retaining element and the second retaining element;
a side rail locking mechanism comprising:
a side rail bracket connected to the adjustable side deck comprising:
a bottom surface;
a first aperture extending through the side rail bracket and the bottom surface; and
an extension tab extending away from the first aperture, the extension tab having a second aperture extending therethrough;
a second tab pivotally connected to the adjustable side deck; and
a locking member connected to the first tab and extending through the second aperture,
whereby rotation of the first tab away from the deck frame releases the latch from the bottom bracket and allows for movement of the adjustable side deck between a retracted position and an expanded position,
whereby rotation of the second tab away from the side rail bracket urges the locking member to move at least partially through the second aperture and away from the side rail bracket.

12. The expansion control assembly of claim 11 further comprising a compression element connected between the adjustable side deck and the latch, wherein the compression element urges the engaging element towards the bottom bracket.

13. The expansion control assembly of claim 11, wherein the adjustable side deck is placed in the retracted position when the engaging element engages the first retaining element.

14. The expansion control assembly of claim 11, wherein the adjustable side deck is placed in the expanded position when the engaging element engages the second retaining element.

15. The expansion control assembly of claim 11, wherein the sliding member comprises at least one cylindrical body.

16. The expansion control assembly of claim 11, wherein the second tab is positioned proximate the first tab.

17. The expansion control assembly of claim 11, wherein the latch comprises a first side member and a second side member, wherein the second tab extends downwardly between the first side member and the second side member.

18. The expansion control assembly of claim 11 further comprising a side rail assembly comprising an attachment member, wherein the attachment member is demountably connected to the expansion control assembly via insertion of the attachment member into the first aperture.

19. A method of moving an adjustable side deck comprising the steps of:
providing an expansion control assembly connected between a deck frame and an adjustable side deck, the expansion control assembly comprising:
a stabilizer connected to the deck frame; the stabilizer having a lateral receiver and a sliding member extending through the lateral receiver, the sliding member connected to the adjustable side deck;
a bottom bracket connected to the stabilizer; the bottom bracket comprising a first retaining element and a second retaining element; and
a latch pivotally connected to the adjustable side deck, the latch comprising a first tab and an engaging element configured to engage the first retaining element and the second retaining element;
pulling the first tab away from the deck frame;
rotating the latch away from the bottom bracket;
sliding the latch away from the deck frame;
releasing the first tab; and
engaging the engaging element with the second retaining element; thereby moving the adjustable side deck from a retracted position associated with the first retaining element to an expanded position associated with the second retaining element.

20. The method of moving an adjustable side deck of claim 19, further comprising the steps of:
pulling the first tab away from the deck frame;
rotating the latch away from the bottom bracket;
sliding the latch towards the deck frame;
releasing the first tab; and
engaging the engaging element with the first retaining element; thereby moving the adjustable side deck from an expanded position associated with the second retaining element to a retracted position associated with the first retaining element.
